(19) United States
(12) Patent Application Publication
(10) Pub. No.: US 2003/0117982 A1
(43) Pub. Date: Jun. 26, 2003

(54) Packet efficient TDMA with flow control

(75) Inventor: James A. Minnick, Central City, IA (US)

Correspondence Address: SIEMENS CORPORATION, INTELLECTUAL PROPERTY LAW DEPARTMENT, 170 WOOD AVENUE SOUTH, ISELIN, NJ, 08830, US

(73) Assignee: Siemens Transportation Systems, Inc.

(21) Appl. No.: 10/315,521

(22) Filed: Dec. 10, 2002

Related U.S. Application Data
(60) Provisional application No. 60/341,585, filed on Dec. 17, 2001.

(51) Int. Cl. H04J 3/00

(52) U.S. Cl. 370/337; 370/442

(57) ABSTRACT

A system for communicating between a base station and a plurality of vehicles over a two-way communication system allows the mobile vehicles to request air time to send a message. Within the request to send signal is an identifier providing the base station with an identification of the priority level for the particular message. As an example, if the mobile vehicles are public safety vehicles, a message having some urgency would have a high priority, while a more routine report might have a lower priority. The base station will receive the request to send signals and schedule transmission of the longer message from the vehicle based initially upon the priority level. Thus, an emergency signal from the vehicle to the base would be scheduled before a more routine signal based upon the priority information provided in the request to send signal. The base then schedules the transmission of the longer message from each of the mobile vehicles based upon the priority identifier. In this fashion, the information being transmitted to and from the mobile vehicles is handled more in line with the immediate needs of the particular mobile vehicle.

### CROSS-REFERENCE TO RELATED APPLICATIONS

The application claims priority to U.S. Provisional Application No. 60/341,585, which was filed on Dec. 17, 2001.

### BACKGROUND OF THE INVENTION

This invention relates to a TDMA two-way data exchange system wherein the flow control between the several mobile units reporting to a base unit is scheduled based upon priority embedded in a request to send signal.

In the prior art, a base station is in communication with a plurality of mobile units through a number of two-way radio links. One standard type is a so-called TDMA (time division multiple access) system.

The systems are such that each of several mobile units receives reports from the base station, and sends reports to the base station on the same “air.” Only one signal can be transmitted at any one time. Thus, reports from each of the several mobile units must be “scheduled” from the base station to ensure that the mobile units are not reporting over each other, or attempting to report over each other.

This type of system is utilized in a number of public safety applications. As an example, police departments, fire departments, EMS, etc. often rely on such systems.

The typical procedure known in the prior art is for the base station to receive incoming packets, and to transmit outgoing packets. The incoming packets typically include slots which are reserved for “request to send” (“RTS”) from any one of the mobile units. The mobile unit, when it wishes to send a signal to the base unit, will place an RTS signal in one of the RTS slots. This RTS signal includes packet size information, and perhaps information about the type of signal. The base receives the request to send, and then schedules slot time for the particular mobile unit to transmit the identified signal. The scheduling information is transmitted from the base to the mobile unit on an outgoing packet. Thus, the base will receive RTS signals from the mobile unit, and will process the received RTS signals to schedule a time when each of the mobile units should transmit signals. In the past, the scheduling has been done chronologically, and has not incorporated any prioritization. While the features discussed above are not all disclosed in prior U.S. Pat. No. 5,854,787, the general outline of this system is disclosed.

Particularly when these systems are utilized in public safety systems, it would be desirable for the base station to recognize that each request to send from a vehicle should not be given equal treatment. As an example, one police vehicle may be transmitting relatively routine information, while another police vehicle is in high speed pursuit, or has pulled over a suspect vehicle. The RTS from the police vehicle in pursuit, or with the pulled over suspect vehicle should perhaps be given a higher priority to have its message sent to the base station for processing. As an example, a police vehicle in pursuit requesting information on a license plate, or a police vehicle with a suspect car pulled over requesting warrant information on the driver, should have a higher priority than a request to send to transmit a routine vehicle location report. However, in the prior art, no such prioritization has been provided.

### SUMMARY OF THE INVENTION

In a disclosed embodiment of this invention, the request to send signal sent from the mobile vehicle to the base station includes a prioritization identifier. As an example, certain types of information might be identified as high priority, neutral priority, or below neutral priority. The base station upon receiving the signal will lump these signals within their priority range, and schedule “air time” for the mobile vehicle to transmit the particular message chronologically within the priority range. Thus, in the above-referenced examples, the police vehicle in high speed pursuit would send a high priority request for license information which would be given priority over another police vehicle sending a more neutral level vehicle location report. In this fashion, the vehicles in need of the quickest processing and return information will receive same.

In disclosed embodiments of this invention, request to send slots are reserved in each of the incoming packets. Each police vehicle will periodically broadcast a request to send, and the request to send signals will be received by the base station. Scheduling software at the base station will prioritize the signals to be sent based first upon the priority level, and then perhaps chronologically within each of the priority levels. The base station then sends an outgoing packet which includes a slot directed to the requesting vehicle scheduling the transmission of the vehicle's particular message signal. Again, the scheduling will occur more promptly for the higher priority message request to send signals.

These and other features of the present invention would be best understood from the following specification and drawings, the following of which is a brief description.

### BRIEF DESCRIPTION OF THE DRAWINGS

FIG. 1 is a schematic view of an overall two-way communication system.

FIG. 2 is a flow chart of the inventive system.

FIG. 3 is a sample message packet.

FIG. 4 is a table showing an exemplary message load.

### DETAILED DESCRIPTION OF A PREFERRED EMBODIMENT

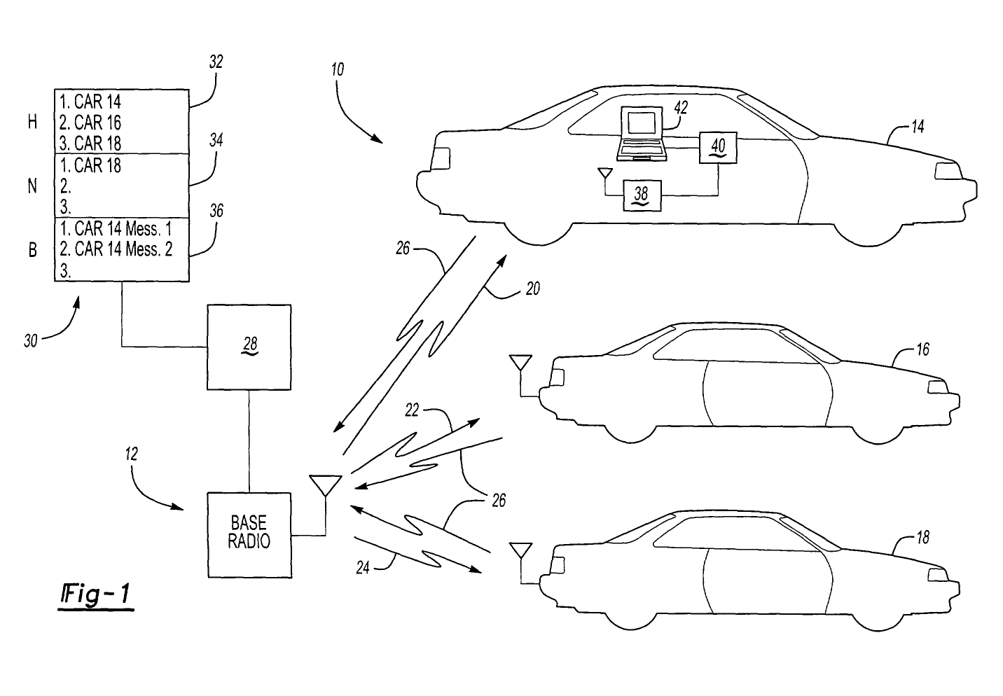

FIG. 1 shows a two-way communication system 10 incorporating a base station 12 having a radio for transmitting and receiving signals to a plurality of mobile vehicles, such as shown schematically at 14, 16 and 18. Additional components are shown on vehicle 14 but the other vehicles are provided with similar components. In practice, there are typically many more than three mobile vehicles on the system.

The base radio 12 can transmit signals 20, 22 and 24 to each of the individual vehicles 14, 16 and 18. Further, the base station 12 can receive signals 26 from each of the mobile vehicles 14, 16 and 18.

A controller for the base radio 28 receives and processes those signals. As an example, the signals may be sent to an appropriate operator to facilitate a search such as a license plate or warrant search. This aspect of the invention is well within the skill of a worker in this art, and is part of the prior art. What is inventive here is the scheduling software 30 which is incorporated within the controller 28 and details of the RTS portion of signal 26. As shown, the scheduling software 30 is able to identify different levels of priority from the signals. In the illustrated embodiment, there is a high level 32, a neutral level 34 and a below neutral level 36. Of course, additional levels (or only two levels) of priority can be defined. The scheduling software 30 schedules these messages for transmission based first upon their priority, and then perhaps chronologically within the priority level. Thus, three signals from car 14, car 16 and car 18 in the high category are scheduled for transmission in that order. The neutral signal from car 18 would be scheduled for transmission after transmission of each of the high level signals. The low level signals would be scheduled for transmission after both the high and neutral level transmissions.

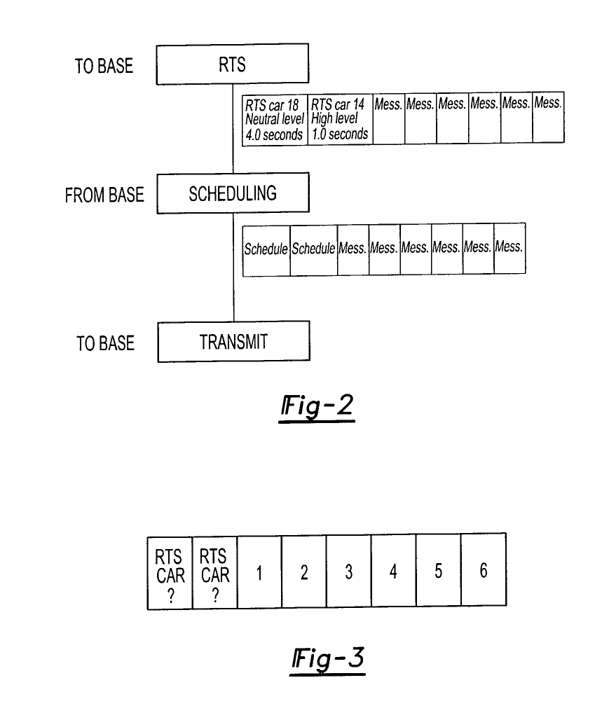

As explained better in FIG. 2, and as generally known within the prior art, the mobile vehicle will initially send a request to send (RTS) signal to the base. This request to send will give some information about the message to be sent, and in particular at least the message length, and perhaps the estimated time required for transmission. In the present invention, this request to send would also include a priority level. Thus, a request to send, such as shown in a sample incoming data packet in FIG. 2, would include a high level request to send from vehicle 14 which was transmitted after a neutral level request to send from vehicle 18. When this signal is received at the base, it heads to the scheduling software 30. The scheduling software would schedule transmission of each of the signals from vehicle 14 and vehicle 18. An outgoing packet would be sent to vehicles 14 and 18 scheduling their transmission. The transmitted messages would be sent in the message slots of a subsequent incoming packet. As would be appreciated, even though the signal from vehicle 14 came in after the signal from vehicle 18 chronologically, the higher priority level would cause it to be scheduled for transmission from vehicle 14 earlier than the transmission of the neutral level signal from vehicle 18.

Essentially, the vehicles request time to send a longer message, and the scheduling software is operable to optimize the transmission of the messages from the vehicles 14, 16 and 18 to the base 12. The present invention includes the ability to prioritize categories of messages from within the wide range of signals which may be sent. An example of the types of messages which could be sent in an exemplary system, and their estimated size, packet size, and priority is shown in FIG. 4. Again, these are simple examples, and the operator of any one system would be able to schedule the appropriate priority. Moreover, it is within the scope of this invention that an operator of the police vehicle could enter into the laptop 42 within the vehicle a request to increase the priority for any particular reason. Thus, if for some reason the priority of a particular signal should be moved up based upon exigent circumstances, the police operator would be able to do so. Each vehicle 14, 16 and 18 includes a laptop 42 communicating with a controller 40 which in turn communicates with model 38. This portion of the invention works as in the prior art, other than the inclusion of the priority information into the request to send signal.

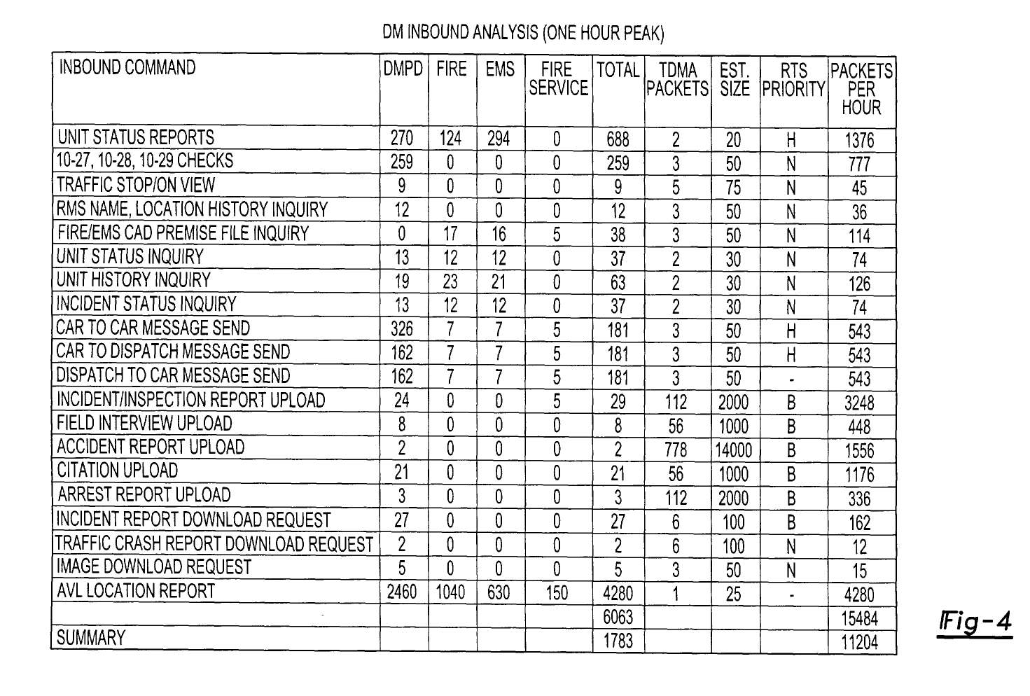

FIG. 3 shows a sample incoming packet sent from the vehicles back to the base. As shown, it is preferred that the first two slots are reserved for RTS signals. The next six slots may be normally reserved for AVL (automatic vehicle location) information. However, should one of the vehicles need to send a message at any one time, those messages would typically take priority over AVL signals. Thus, should a car to dispatch message having a high priority need to be sent, the AVL signals would not be scheduled during the time that it would take for this message to be sent. On the other hand, if only a shorter message is to be sent which would not take each of the six extra slots, it may be that an incoming packet could be a “mixed” packet including both the message information, and the AVL information. Again, the scheduling software would schedule that ordering as appropriate for the particular combination for the requests to send, and normal vehicle reporting such as the AVL reports which may be occurring at any time.

Although preferred embodiments of this invention have been disclosed, a worker of ordinary skill in the art would recognize that certain modifications would come within the scope of this invention. For that reason, the following claims should be studied to determine the true scope and content of this invention.

1. A method of communicating between a base and a plurality of mobile vehicles over a single two-way communication system comprising the steps of:
(1) requesting time to send a message from any one of said plurality of mobile vehicles to said base station by sending a request to send signal, said request to send signal including a priority identifier such that the priority of an associated message can be identified by a controller associated with said base;
(2) receiving said request to send signal at said base, and evaluating the priority identifier within the request to send signal, ordering the timing of the transmission of the messages from said mobile vehicle to said base station based upon said priority information in said request to send signal, and sending scheduling information from said base station to said mobile vehicle, said mobile vehicle sending said message based upon said scheduling information.

2. A method as set forth in claim 1, wherein there are a plurality of vehicles transmitting request to send signals to said base station, and scheduling software performs the scheduling of said message transmission based upon said priority identifier.

3. A method as set forth in claim 2, wherein within any one priority identifying level, the signals are then scheduled based upon the chronological time of receipt.

4. A method as set forth in claim 1, wherein said mobile vehicles are public safety vehicles.

5. A two-way communication system for communicating between a base station and a plurality of vehicles comprising:
a base station for sending and receiving signals from a plurality of mobile vehicles;
a plurality of mobile vehicles each having a system for transmitting and receiving signals from said base station, said plurality of mobile vehicles sending a request to send a signal to said base station when it is desired to send a message from said mobile vehicle to said base station, said request to send signal including a priority identifier, and said base station receiving said request to send signals, and ordering a schedule of transmission of said messages from said mobile vehicles based upon said priority identifier, said base station sending a schedule to each of said mobile vehicles including the scheduled time for transmission of a particular message from said mobile vehicle, said scheduled time being selected based upon said priority identifier in said request to send signal.
